(19) United States
(12) Patent Application Publication
(10) Pub. No.: US 2008/0025560 A1
(43) Pub. Date: Jan. 31, 2008

(54) Photographic image processing apparatus

(76) Inventors: Koichi Kugo, Wakayama-shi (JP); Noriyuki Nishi, Naga-Gun (JP); Yuki Tsuji, Wakayama-shi (JP)

Correspondence Address: SMITH PATENT OFFICE, 1901 PENNSYLVANIA AVENUE N W, SUITE 901, WASHINGTON, DC, 20006, US

(21) Appl. No.: 11/826,616

(22) Filed: Jul. 17, 2007

(30) Foreign Application Priority Data
Jul. 28, 2006 (JP) 2006-206693

(51) Int. Cl. G06K 9/00

(52) U.S. Cl. 382/100

(57) ABSTRACT

A photographic image processing apparatus, which detects a skin domain appropriately using a simple method, and distinguishes automatically whether it is a harmful image, is provided with a photographic image distinction unit (36) that includes a face information extraction unit (41) which detects a person's face domain from inputted color image data and extracts color difference data of the skin of the face domain, a skin domain detecting unit (42) which detects a domain correlated with the color difference data of the skin from the color image data as a skin domain, a domain distinction unit (43) which distinguishes the domain continuity between the face domain and the skin domain, and an image distinction unit (45) which calculates the area ratio between the face domain and the skin domain distinguished by the domain distinction unit (43) as a continuous domain and distinguishes whether or not the color image data includes any non-clothed portrait image based upon the area ratio.

### BACKGROUND OF THE INVENTION

1. Field of the Invention

The present invention relates to a photographic image processing apparatus which generates and outputs photograph prints in a predetermined order based on two or more pieces of print order information that have been inputted.

2. Description of the Related Art

In a photograph print shop or a mini-lab., which is a small business that develops film and makes prints quickly often using computerized equipment, or the computerized equipment itself, when an operator carries out print processing on film images and digital images picked up with a digital camera that have been entrusted by a customer by using a photograph printing apparatus, the operator displays thumbnail images corresponding to frame images, each of which means an image developed into a photographic film corresponding to a frame or recorded by a digital camera and the like, and is to be referred to simply as “a frame image” hereinafter, to be printed on a monitor screen of the photograph print apparatus, and carries out an image inspection process for manually correcting colors, concentrations and the like. At this time, when the operator finds any harmful image such as a pornographic image that offends public order and morals, in which a person without clothes is picked up as a subject, he or she can perform a setting operation to avoid conducting print processing on the corresponding image.

Further, the photograph printing apparatus of this kind is also provided with an automatic processing mode that automatically adjusts colors, concentrations and the like to generate a proper photograph print without the necessity of carrying out the image inspection process by the operator.

Therefore, in the case where a photograph print is generated in the automatic processing mode and shipped, in terms of promoting efficiency of the work by the operator, reducing personnel expenses, etc., there is a possibility that the above-mentioned harmful image which should not be shipped might be shipped accidentally.

Here, with respect to the technique for preventing circulation of harmful images over the Internet, proposed in Japanese Laid-Open Patent Publication No. 2004-102662 is a filtering data server in which, by installing a filtering database that can be shared by a plurality of users, information such as harmful information and the like are stored in the shared filtering database, thereby eliminating door-to-door sellers, telemarketing calls, accesses to harmful information over the Internet, etc.

Moreover, with respect to the image analyzing technique for determining whether or not it is a harmful image, the following technique is disclosed in Japanese Laid-Open Patent Publication No. 2002-175527. First, it is determined which one of predetermined combination patterns of areas a plurality of skin color domains extracted from image data divided into domains belong to, and feature values of the skin color distribution are obtained based upon the areas and the centers of gravity of the plurality of skin color domains. Next, with respect to each of the individual skin color domains, the feature value of the skin color distribution is compared with the standard set according to the patterns that matches the combination pattern of area to which the skin color domain is determined to belong, and the images that are not determined as harmful images are excluded. Those images that are not excluded are compared with patterns of predetermined face image data, so that the images that are not determined as harmful images are further excluded; thus, the images that have not been excluded yet are determined as harmful images.

However, the filtering data server disclosed in Japanese Laid-Open Patent Publication No. 2004-102662 exerts its effects only on images that are shared in the above-mentioned filtering server, and fails to provide a specific technique for analyzing whether or not an individual image is a harmful image.

Moreover, the method of discriminating harmful images disclosed in Japanese Laid-Open Patent Publication No. 2002-175527 is a method in which comparison is made between composition patterns of skin domains divided based upon edges of brightness or hue and composition patterns of skin domains obtained by analyzing a large number of pornographic photo samples to find the degree of coincidence; however, since there are considerable differences in the hues of the skin domain depending on races, it is not easy to appropriately extract skin domains such as a head portion and a torso portion from a subject image, and complicated processes are required for the discrimination process to cause a heavy processing load, with the result that it is difficult to apply this method to a photograph printing apparatus that needs to process a large number of photographic images within a short time.

The inventors of the present application have been studying a discrimination method for non-clothed portrait images, which is suitable for the image processing for photograph prints; however, since those images distinguished as non-clothed portrait images by using the discrimination method are not necessarily determined as the harmful images to be eliminated, it is difficult to automatically avoid print processing of harmful images.

Therefore, there is no other choice but to eventually call for the determination by the operator's eyes, and in this case, with respect to each of a large number of frame images included in print order information, each time a certain image is distinguished as a non-clothed portrait image, an image inspection process is required individually, and time-consuming processes are required to cause lowering of manufacturing efficiency of the photograph prints.

### SUMMARY OF THE INVENTION

In view of the foregoing problems, an object of the present invention is to provide a photographic image processing apparatus which, while automatically distinguishing whether a frame image included in print order information includes any non-clothed portrait image, allows the operator to easily carry out determination with eyes prior to the print processing, without causing any decline in manufacturing efficiency of photograph prints.

In order to achieve the above-mentioned object, a photographic image processing apparatus in accordance with the present invention, which generates photograph prints in a predetermined order based upon a plurality of pieces of inputted print order information to output the photograph prints, includes: an image inspection unit which displays thumbnail images corresponding to one or a plurality of pieces of frame image data included in the inputted print order information on a display unit, and is capable of carrying out a predetermined inspection process on the frame images corresponding to the displayed thumbnail images; a mode switching unit which switches modes between an inspection print mode that generates a photograph print based on a result of the inspection by the image inspection unit and an automatic print mode that generates a photograph print without using the image inspection unit; and a photographic image distinction unit which distinguishes whether or not any non-clothed portrait image is included in the frame image data included in the print order information, and in this structure, the mode switching unit switches the mode from the automatic print mode to the inspection print mode based upon a result of the distinction by the photographic image distinction unit.

When it is distinguished by the photographic image distinction unit that the frame image data includes a non-clothed portrait image, the mode switching unit preferably switches the mode from the automatic print mode to the inspection print mode only for the frame image.

Moreover, when it is distinguished by the photographic image distinction unit that the frame image data includes a non-clothed portrait image, the mode switching unit preferably switches the mode from the automatic print mode to the inspection print mode only for one or a plurality of frame images that have been distinguished as including a non-clothed portrait image on the basis of the print order information including the corresponding frame image as one unit.

Furthermore, when it is distinguished by the photographic image distinction unit that the frame image data includes a non-clothed portrait image, the mode switching unit preferably switches the mode from the automatic print mode to the inspection print mode for all the frame images on the basis of the print order information including the corresponding frame image as one unit.

Other aspects of the invention will become apparent from the following description of preferred embodiments.

### BRIEF DESCRIPTION OF THE DRAWINGS

FIG. 1 is an explanatory diagram of a photographic image processing apparatus in accordance with the present invention;

FIG. 2 is an explanatory diagram of a photograph print order system;

FIG. 3 is an explanatory diagram of a reception terminal;

FIG. 4 is an appearance view of the photographic image processing apparatus;

FIG. 5 is a functional block diagram of a photographic image distinction unit;

FIG. 6A is an explanatory diagram showing a face domain detected from a photographic image;

FIG. 6B is an explanatory diagram showing a skin domain detected from the photographic image;

FIG. 6C is an explanatory diagram showing a domain continuity of the skin domain detected from the photographic image;

FIG. 6D is an explanatory diagram showing a detection procedure of a specific domain;

FIG. 7A is an explanatory diagram of a labeling process showing a state where a label is attached to a first pixel;

FIG. 7B is an explanatory diagram of the labeling process showing a state where a label is attached to a pixel which is adjacent to the first pixel;

FIG. 7C is an explanatory diagram of the labeling process showing a state where labels are attached to all pixels;

FIG. 7D is an explanatory diagram of a labeling process that deals with an image having three domains;

FIG. 7E is an explanatory diagram of the labeling process showing a state where labels are attached to the image having the three domains;

FIG. 8 is an explanatory diagram of a screen displayed by an image inspection unit;

FIG. 9A is an explanatory diagram showing an example of frame images included in print order information;

FIG. 9B is an explanatory diagram showing a screen at the time of changing only the frame image including a non-clothed portrait image to an inspection print mode;

FIG. 9C is an explanatory diagram showing a screen at the time of changing all the frame images to the inspection print mode;

FIG. 10 is a flowchart illustrating a first operational mode of the photographic image processing apparatus;

FIG. 11 is a flowchart illustrating a second operational mode of the photographic image processing apparatus;

FIG. 12 is a flowchart illustrating a third operational mode of the photographic image processing apparatus; and

FIG. 13 is a flowchart illustrating a fourth operational mode of the photographic image processing apparatus.

### DESCRIPTION OF THE PREFERRED EMBODIMENTS

The following description will explain embodiments to which a photographic image processing apparatus in accordance with the present invention is applied as one portion of a photograph print order system.

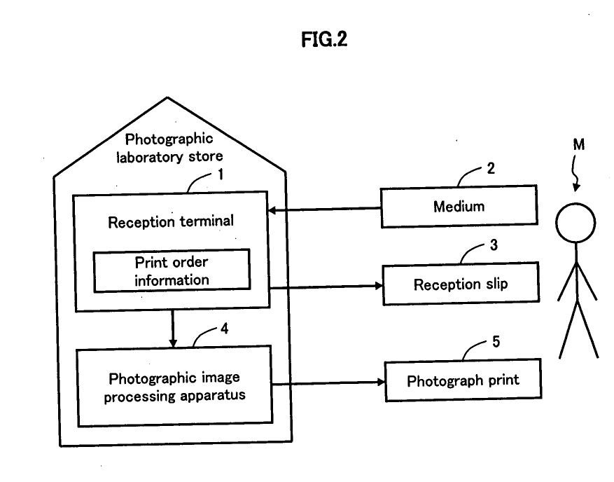

As shown in FIG. 2, a photograph print order system is equipped with a plurality of reception terminals 1 installed in a photographic laboratory store and a photograph printing apparatus that serves as a photographic image processing apparatus 4 which generates photograph prints based on print order information that is inputted to each reception terminal 1.

A customer M comes to the store, inserts a medium 2 in which photographic image data photographed with a digital image-pickup apparatus, for example, such as a digital camera built into a mobile telephone, into a media drive that is attached to a reception terminal 1, and when ID information including a name, a contact, etc., specifying information on the image information to be printed, the number of prints, print size, etc. are inputted through the reception terminal 1, it is arranged so that a reception slip 3 is outputted from a built-in printer.

In the reception terminal 1, print order information is generated based upon the ID information, the specifying information on the images to be printed, the number of prints, the print size, etc., thus inputted, and the print order information is transmitted to the photographic image processing apparatus 4, so that photograph prints 5 are generated based upon the received print order information in the photographic image processing apparatus 4.

When, at the estimated time for print finish that is printed in the reception slip 3, the customer M shows a clerk at the reception counter of the photographic laboratory store the reception slip 3 and pays the charge, the photograph prints are handed over.

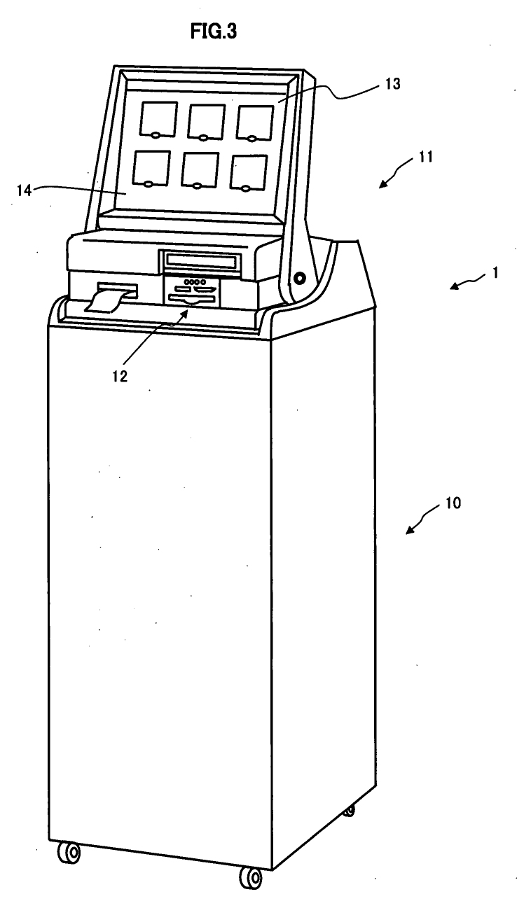

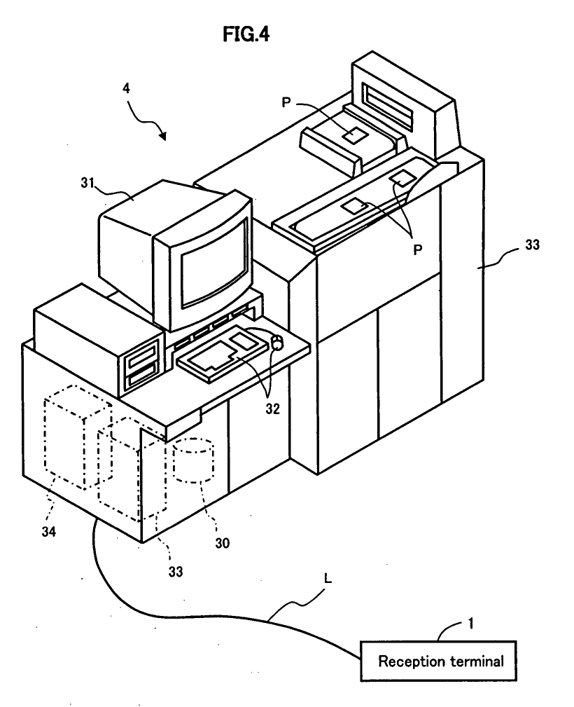

As shown in FIG. 3, the reception terminal 1 is constituted by a case 10 and a photograph order reception processing unit 11 arranged on the upper portion of the case 10, and as shown in FIG. 4, the photograph order reception processing unit 11 and the photographic image processing apparatus 4 are connected to each other via a data-communication line L.

The photograph order reception processing unit 11 is configured by a plurality of kinds of media drives 12 which constitute a data input unit used for reading photographic image data stored in the medium 2 that is one of various kinds of portable media such as a CD, a CF card and an SD memory that a customer possesses, a liquid-crystal-display unit 13 which is a display unit to display the photographic images read by the media drive 12, and a touch-panel 14 or the like that is arranged on the surface of the liquid-crystal-display unit 13 and used as an input unit to input the order data such as the number of prints, print size, etc., with respect to the photographic images displayed on the liquid-crystal-display unit 13.

The photographic image processing apparatus 4 is designed such that photograph prints are generated and outputted in a predetermined order based on a plurality of pieces of print order information transmitted through the data-communication line L from each reception terminal 1.

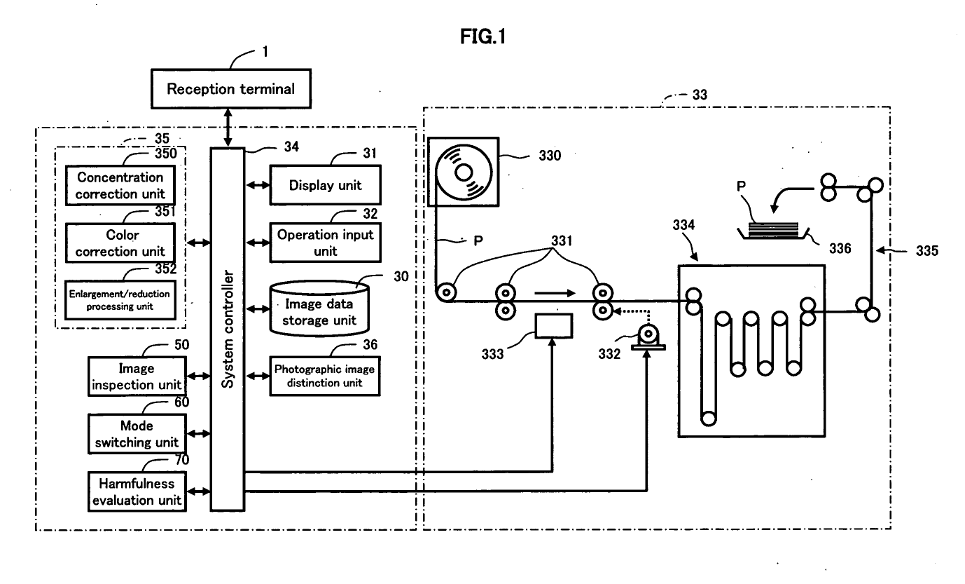

As shown in FIGS. 1 and 4, the photographic image processing apparatus 4 is provided with respective blocks including: an image data storage unit 30 that is configured by a hard disk or the like which stores a series of frame image data included in the print order information that has been inputted from the reception terminal 1, a display unit 31 which displays thumbnail images corresponding to respective frame images based upon the frame image data, an operation input unit 32 equipped with a keyboard or a mouse, and a photograph print unit 33 which exposes printing sheet P based on the data after having been subjected to image processing by an image-processing-unit 35, which will be described later, and generates photograph prints.

Moreover, the photographic image processing apparatus 4 is provided with a system controller 34 which controls each of the above-mentioned blocks as a system, based upon an application program installed under management of a predetermined operating system, the image-processing unit 35 which carries out edit-processing on the image data based upon various pieces of operation information inputted through the operation input unit 32 with respect to the photographic images displayed on the display unit 31, or automatically carries out the edit-processing on the image data without the use of the operation input unit 32, a photographic image distinction unit 36 which distinguishes automatically whether any non-clothed portrait image is included in the frame image data included in the print order information, and the like.

Furthermore, the photographic image processing apparatus 4 is provided with a harmfulness degree evaluation unit 70 which evaluates the degree of harmfulness of the image data that has been distinguished by the photographic image distinction unit 36 as including any non-clothed portrait image, an image inspection unit 50 which displays thumbnail images corresponding to one or more pieces of frame image data included in the inputted print order information on the display unit 31 and is capable of carrying out a predetermined inspection process on the frame images corresponding to the displayed thumbnail images, and a mode switching unit 60 which switches modes between an automatic print mode that generates a photograph print without the use of the image inspection unit 50 and an inspection print mode that generates a photograph print based upon the result of inspection by the image inspection unit 50.

The photograph print unit 33 is provided with a paper magazine 330 in which roll-shaped printing sheet P is accommodated, a plurality of printing sheet conveyance rollers 331 that pull out and convey the printing sheet P from the paper magazine 330, a motor 332 that drives the conveyance rollers 331, a print head 333 of a fluorescent beam system that exposes the photosensitive face of the printing sheet P conveyed by the conveyance rollers 331, a developing treatment unit 334 that carries out respective processes of developing, bleaching and fixing on the printing sheet P that has been exposed, a drying unit 335 that conveys the printing sheet P that has been subjected to the developing treatment while drying the printing sheet P, and a discharge unit 336 which discharges the dried printing sheet P as a finished print.

The printing sheet P pulled out from the paper magazine 330 is cut into a predetermined print size by a cutter (not shown) arranged at any position before and after the developing treatment, and is outputted to the discharge unit 336.

The print head 333 is configured by a laser-type exposure optical system that modulates bundle of rays that are outputted from lasers having respective wavelengths of red, green and blue and scanned by a rotating polygon mirror, based upon respective pieces of pixel data corresponding to R component, G component and B component of the photographic image data that has been edit-processed by the image-processing unit 35, which will be described later, so that the corresponding photographic image is exposed on the printing sheet P.

The system controller 34 is provided with a ROM in which a program that operates the photographic image processing apparatus 4 is stored, a RAM used as a data-processing domain, as well as for editing photographic image data, a CPU which executes the program, and peripheral circuits, and controls each of the blocks of the photographic image processing apparatus 4 based on the program.

The image-processing unit 35 is equipped with a concentration correction unit 350 that carries out gray level correction on each of the photographic images displayed on the display unit 31, a color correction unit 351 that adjusts a color-balance, and an enlargement/reduction processing unit 352 that carries out an enlarging or reducing process on the subject image.

Upon selection of a mode that automatically corrects an image by the operator through the operation input unit 32, the system controller 34 activates the image-processing unit 35 to carry out required image processing operations such as concentration correction and color-balance correction in succession on the frame images included in the print order information that has been inputted from the reception terminal 1, while it also activates the photographic image distinction unit 36 to cause the unit 36 to automatically distinguish whether or not the image data include any non-clothed portrait image.

Here, upon selection of a mode that carries out manual correction on an image by the operator through the operation input unit 32, image processing and photographic image distinction processing are activated on the basis of each piece of print order information by the operation of an operation button displayed on the operation screen, and thumbnail images corresponding to the respective frame images included in the print order information are displayed on the display unit 31. The operator manually carries out an image correction treatment on each of the images displayed on the display unit 31, and also performs inspection processing so as to prevent harmful images from being printed out.

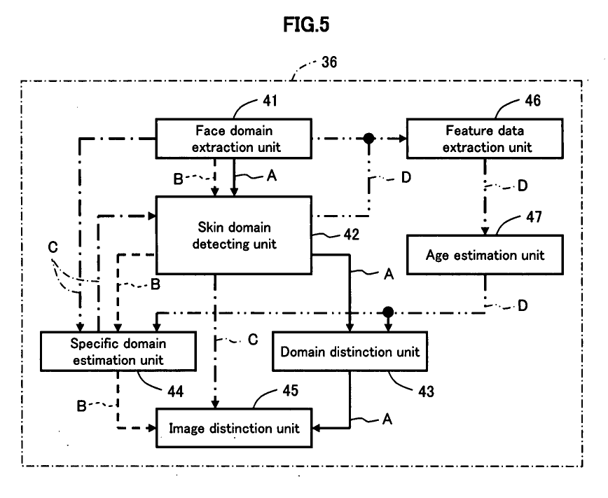

As shown in FIG. 5, the photographic image distinction unit 36 is provided with a face information extraction unit 41 that detects a person's face domain from the inputted color image data, a skin domain detecting unit 42 that detects a person's skin domain from the image data, and a domain distinction unit 43 that distinguishes the domain continuity between a face domain and a skin domain, a specific domain estimation unit 44 that estimates a specific domain corresponding to a person's specific part from the image data, and an image distinction unit 45 that distinguishes whether or not the image data include any non-clothed portrait image.

In each of these processing units, as shown in FIG. 5, by processing data by using any of three kinds of processing courses, that is, Processing A (solid line arrow), Processing B (dotted line arrow) and Processing C (dashed-dotted line arrow), it is distinguished whether or not any portrait image without clothes is included.

Furthermore, the photographic image distinction unit 36 is provided with a feature data extraction unit 46 that extracts pose feature data from a face domain or a skin domain, and an age estimation unit 47 that estimates a photographic subject's age based upon the pose feature data, and as shown by process D (dashed-two dotted line arrow) in FIG. 5, by using the age estimation unit 47, the age of the subject is added to the result of distinction as to whether or not any portrait image without clothes is included, in the image distinction unit 45.

The face information extraction unit 41 detects a person's face domain from the inputted color image data, and it is configured such that color difference data of the skin of a face domain, a direction of the face domain, and a size of the face domain can be extracted.

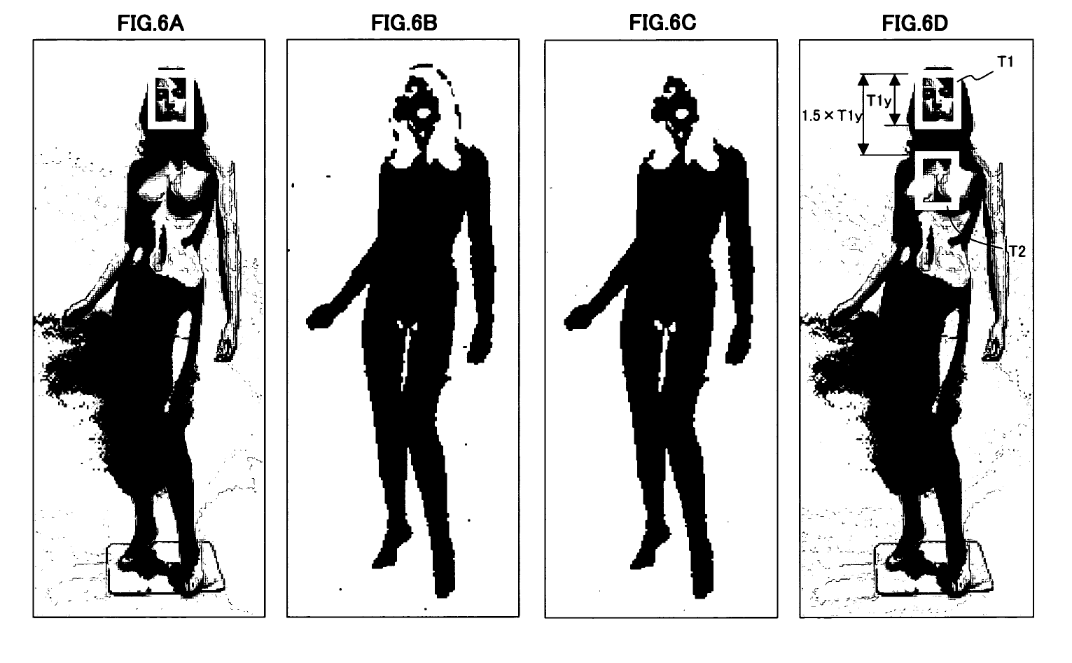

Detection of the face domain of a person from the inputted color image data can be achieved by using known techniques, such as a technique in which whether or not the outline obtained based upon the concentration edge and color edge that have been extracted from color image data, corresponds to a face domain is detected based upon the pattern recognition technology in which the degree of coincidence with respect to a plurality of element arrangement patterns such as an outline of the face domain, eyes, a nose, a mouth and ears, prepared beforehand, is evaluated. As a result, for example, as shown in FIG. 6A, the detected face domain is displayed with a rectangular frame.

The color difference data of the skin of a face domain are calculated as a Cb component (color difference of brightness and blue) and a Cr component (color difference of brightness and red) of the YCC color system that are obtained by calculating an average value for respective R components, G components and B components of all the pixels constituting the detected face domain and substituting the average value of the respective components for [Equation 1] to be converted into values of the YCC color system.

Hereinafter, the Cb component of the color difference data of the skin of a face domain is denoted as Cbs, the Cr component thereof is denoted as Crs, and these are denoted as (Cbs, Crs) in combination. In addition, by using only the Cb component and the Cr component without using a Y component (brightness), light and dark factors, which are unnecessary in identifying a face domain and a skin domain, can be excluded.

$$\{ \begin{matrix}Y = 0.29891 ⨯ R + 0.58661 ⨯ G + 0.11448 ⨯ B \\ Cb = - 0.16874 ⨯ R - 0.33126 ⨯ G + 0.50000 ⨯ B \\ Cr = 0.50000 ⨯ R - 0.41869 ⨯ G - 0.08131 ⨯ B\end{matrix} \qquad [ Equation 1 ]$$

The face information extraction unit 41 calculates relative positional relationships between a plurality of elements such as an outline, eyes, a nose, a mouth and ears of the detected face domain, for example, as coordinates information, and by comparing the coordinates information thus calculated with direction patterns of a face that are preliminarily registered as face direction patterns corresponding to relative positions between various elements, the direction of the face domain is obtained, and the number of all the pixels in the detected face domain is calculated as the size of the face domain. For example, the area of the rectangular frame in FIG. 6A is calculated as the size of a face domain.

The skin domain detecting unit 42 is configured such that a domain that is correlated with the color difference data of the skin extracted in the face information extraction unit 41 is detected as a skin domain from the color image data or a specific domain which will be described later.

The detailed explanation is given as follows; with respect to all the pixels in the color image data or all the pixels within the specific domain indicated as a rectangular area T2 in FIG. 6D, color difference data (Cbn, Crn) of each pixel is calculated. Here, n represents a number of a pixel, and ranges from 1 (minimum value) to the number of pixel data to be calculated (maximum value).

Next, a distance Dn between the color difference data (Cbn, Crn) calculated for each pixel and the color difference data (Cbs, Crs) of the skin of a face domain is calculated based on [Equation 2], and the resulting value is subjected to a binarizing process depending on whether the distance Dn with respect to each pixel is greater or smaller than a preset threshold value.

As a result of the binarizing process, a domain in which the distance Dn becomes smaller than the threshold value is detected as the skin domain. Here, the calculation of the threshold value used for the binarizing process is carried out, for example, by using a distinction analyzing method or the like in which all the pixels to be subjected to the binarizing process are divided into two classes, and the threshold value is determined so that the separation between the two classes becomes largest.
Dₙ=\sqrt{(C_{bn}−C_{bs})²+(Cᵣₙ−Cᵣₛ)²} [Equation 2]

The result obtained through carrying out the binarizing process on all the pixels of the color image data shown in FIG. 6A to detect the skin domain, is shown in FIG. 6B. In FIG. 6B, the skin domain is indicated by a portion which is colored with black, and domains other than the skin domain are indicated by gray portions (although gray in the figure, these are white in actual operation processing).

The domain distinction unit 43 is designed such that the domain continuity between the face domain detected by the face information extraction unit 41 and the skin domain detected by the skin domain detecting unit 42 are distinguished, and the skin domain detected by the skin domain detecting unit 42, is subjected to labeling processing, and based upon the result, the domain continuity is distinguished.

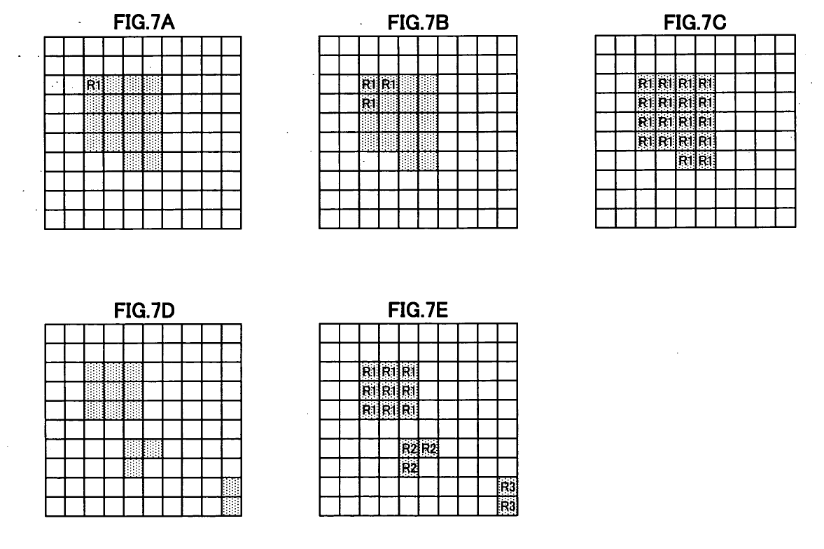

The labeling processing is a process in which, by using the following processes, while pixels that are coupled to one another in a subject image are regarded as one domain, that is, a group of pixels included within predetermined threshold values are regarded as one domain, a common label is successively applied to these. In other words, as shown in FIG. 7A, by finding a pixel to which no label is attached and which satisfies predetermined conditions (here, skin domain colored with black in the binarizing process), a new label R1 is added thereto so that, as shown in FIG. 7B, when, upon scanning a pixel coupled to the pixel to which the new label R1 has been added, the pixel satisfies predetermined conditions, the same label is added thereto. As shown in FIG. 7C, the above-described processes are repeated until pixels to which labels should be added no longer exist within the image.

For example, when the above-described processes are carried out on an image having three skin domains as shown in FIG. 7D, the labels R1 to R3 are attached to the three skin domains located within the respective ranges of predetermined threshold values, as shown in FIG. 7E. Therefore, when the labeling processing is carried out on skin domains, different labels are attached to the respective skin domains located in the color image data.

The distinguishing process of domain continuity is carried out, for example, in the following manner. A searching process is carried out on arbitrary pixels within a face domain, and the label attached to the pixel first searched is determined as the label for the face domain, so that a skin domain to which the same label as that of the face domain is attached is detected as a domain having domain continuity to the face domain.

With respect to image data detected as a skin domain as shown in FIG. 6B, the result of the distinguishing process of domain continuity carried out thereon is shown in FIG. 6C. The portion colored with black in FIG. 6C is the skin domain detected as the domain having domain continuity with the face domain.

The specific domain estimation unit 44 is designed such that the position of each of specific domains corresponding to predetermined specific parts such as chest and abdomen, of the person in the image can be estimated based on the direction of a face domain and the size thereof.

For example, as shown in FIG. 6D, a rectangular area T2, which corresponds to an area obtained by moving the rectangular area T1 obtained from the detection of the face domain to the torso side of the subject by 1.5 times the longitudinal width T1y of the rectangular area T1, is estimated as a specific domain corresponding to the breasts that is a specific part of the person in the image.

In the above-described example, it is estimated based upon the result of statistical analyses on a large number of person's images that the area obtained by moving from the face domain to the torso side of the subject by 1.5 times of the longitudinal width of the face domain, corresponds to the breasts that form a specific domain; however, of course, another configuration adopting another different magnification, not 1.5 times, may be used in moving the area, depending on the specific portion to be estimated. For example, on the basis of a plurality of subject's typical poses, relative positional relationships between specific parts and the direction and size of the face domain may be prepared as estimation data; thus, the location of each of the specific parts can be estimated based on the direction and size of the face domain of the subject.

Although the torso side of the subject is located in the downward direction in the above-described example, the torso side of a subject is not necessarily located in the downward direction, depending on photographic images. For example, in the case of a portrait image in which a person lies down with the head positioned on the left side, the torso side is located in a lateral direction. In such a case, a specific domain is estimated based upon the direction of the face domain. That is, the direction of the face domain is obtained from the relative positions between the elements forming the face, and when the mouth is located in the right side of eyes, the rectangular area as a result of the movement toward the torso side (for example, right side) of the subject is estimated as a specific domain corresponding to the breasts that are a specific part of the person in the image.

The image distinction unit 45 is designed such that based upon either one of the area ratio between a face domain and a skin domain distinguished as a continuous domain in the domain distinction unit 43 or the area ratio between a skin domain and a non-skin domain in a specific domain estimated by the specific domain estimation unit 44 based upon detected information by the skin domain detecting unit 42, a distinguishing process as to whether or not any non-clothed portrait image is included in color image data is carried out.

Here, the ratio of the face to a human's whole body is virtually the same; therefore, in the case where in a portrait image, a subject does not wear clothes, the area ratio between the face domain and the skin domain becomes virtually the same, while in contrast, in the case where the subject wears clothes, the area ratio becomes unnaturally small because the skin domain is reduced by the portion corresponding to the clothes. By conducting statistical analyses on many non-clothed portrait images based upon this fact, a face domain threshold value that forms a standard based on which determination is made as to whether or not the person wears clothes is calculated.

Moreover, when, in a certain image, the area ratio between the face domain and the skin domain is larger than the face domain threshold value, it is determined that the image includes any non-clothed portrait image; in contrast, when the area ratio between the face domain and the skin domain is smaller than the face domain threshold value, it is determined that the image does not include any non-clothed portrait image. In addition, the area of the face domain may be given as either the rectangular area shown in FIG. 6A or the area of the skin domain colored with black in FIG. 6B located inside the rectangular area shown in FIG. 6A.

In the case where the specific domain corresponds to the breasts domain, since almost all the pixels in the domain belong to the skin domain in the case of wearing no clothes, the area ratio of the skin domain to the non-skin domain within the specific domain becomes as large as almost 100%; however, in the case of wearing clothes, the area ratio becomes smaller since the portion of the clothes within the domain does not form the skin domain. In accordance with this tendency, based upon the fact that the area ratio between the skin domain and the non-skin domain within a specific domain becomes virtually the same among different portrait images, statistical analyses are carried out on various specific domains of a large number of non-clothed portrait images, so that a specific domain threshold value that forms a standard based on which determination is made as to whether or not the person wears clothes is calculated.

Therefore, in the case where in a certain image, the area ratio between the skin domain and the non-skin domain in a specific domain is larger than the specific domain threshold value, the image distinction unit 45 determines that a non-clothed portrait image is included in the image, while when the area ratio between the skin domain and the non-skin domain in the specific domain is smaller than the specific domain threshold value, the image distinction unit 45 determines that there is not any non-clothed portrait image included in the image.

The feature data extraction unit 46 is configured such that pose feature data is extracted from the face domain extracted by the face information extraction unit 41 or the skin domain detected by the skin domain detecting unit 42, and various pieces of information, such as information relating to skin contour and information relating to the outlines, for example, the outline of a face, a hairstyle, the height of a nose, the color of lips, wrinkles, and the shape of eyebrows, or the shape of breasts, the outline of torso and arm and leg, the ratio between head and height, and the like, can be extracted as pose feature data.

The extraction of such pose feature data can be carried out by using a known technique, such as a sampling method in which, based on the position of each of the constituent elements of a face, the positions of feature points are set more densely as they are located more closely to the constituent element, while the positions of feature points are set more thinly as they are located more apart from the constituent element, and an extraction method in which a Gabor wavelet transform is executed on the preset feature points so that periodicity and the directivity of the shade characteristic on the periphery of the feature point are extracted as pose feature data.

The age estimation unit 47 is designed such that a subject's age can be estimated based on the pose feature data extracted by the feature data extraction unit 46 and the pose feature data preliminarily sampled from every age group.

The age estimation unit 47 is provided with, for example, a database in which a typical sample image among many sample images for every constituent element or a sample image obtained by averaging many sample images for every constituent element is preliminarily registered as pose feature data for every age group, and by comparing the pose feature data extracted by the feature data extraction unit 46 with the pose feature data preliminarily registered in the database, the age group is estimated for every constituent element, and the age group estimated by the most constituent elements is estimated as the subject's age group.

The image inspection unit 50 is designed to display thumbnail images, which is frame images corresponding to one or a plurality of pieces of the frame image data included in the inputted print order information on the display unit 31 and carry out predetermined inspection processes on the displayed frame images thus displayed. (Hereinafter, “a thumbnail image” is not to be distinguished from “a frame image” and both are to be referred to simply as “a frame image”)

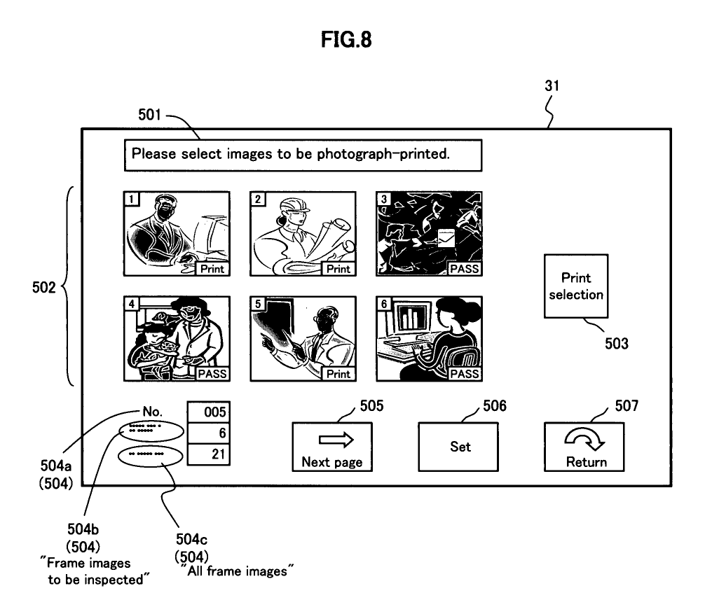

As shown in FIG. 8, in the screen displayed on the display unit 31 by the image inspection unit 50, the following items are arranged: a message display area 501 which displays predetermined messages such as instructions, warning, etc. to the operator, a frame image display frame 502 in which the frame images are displayed, and a print selection switch 503 which allows selection as to whether or not photograph prints are generated with respect to the frame images displayed on the frame image display frame 502 and activated, a number-of-sheets display area 504 where the number of sheets of each frame image included in the print order information etc. is displayed, and a “next page” switch 505 for displaying the frame images which are not displayed on the present screen, a “set” switch 506 which, when pressed, determines the setting of the inspection process by the image inspection unit 50 so that photograph prints are generated with respect to the frame images selected to generate photograph prints thereof, and a “return” switch 507 for returning to the setting screen immediately before the present screen.

The cursor of a mouse which constitutes the operation input unit 32 is moved onto a frame image to be activated, and by clicking the mouse, the corresponding frame image is made active.

By clicking the print selection switch 503 with the mouse, a switching display between “Print” and “PASS” is given at the lower right portion of the frame image which is displayed in the image display frame 502 and is made active, so that selection is made as to whether or not a photograph print should be generated therefor.

In the case where the lower right portion of the frame image currently displayed in the frame image display frame 502 is displayed as “Print”, upon clicking the “set” switch 506 with the mouse, the photograph print of the corresponding frame image is permitted, and in the case where the lower right portion of the frame image currently displayed in the frame image display frame 502 is displayed as “PASS”, the photograph print of the corresponding frame image is inhibited.

The number-of-sheets display area 504 is provided with a “No.” display section 504a which displays the identification number of print order information, an “inspection frame” display section 504b which displays the number of the frame images currently displayed on the display unit 31 among the frame images included in the print order information, and an “all the frames” display section 504c which displays the number of the frame images included in the print order information.

The mode switching unit 60 is designed such that when, upon selection of the automatic print mode, predetermined conditions are satisfied, it switches the modes to the inspection print mode, and by operating the mode switching switch displayed on the display unit 31 in the switched state to the inspection print mode, switching is made to the automatic print mode.

In the inspection print mode, frame images are displayed on the display unit 31 by the image inspection unit 50, and after the operator has manually carries out the selection operation as to whether or not a photograph print is generated with respect to each of the displayed frame images, photograph prints are generated with respect to only the frame images that are selected to generate photograph prints. On the other hand, in the automatic print mode, photograph prints are generated without the selection process performed by the operator as to whether or not photograph prints should be generated.

The photographic image processing apparatus 4 is designed such that even when it is normally operated in the automatic print mode for all the frame images, switching can be made from the automatic print mode to the inspection print mode by the mode switching unit 60 on the frame image basis or on the print order information basis, depending on conditions, that is, based on the distinction result by the photographic image distinction unit 36 with respect to the frame images.

In accordance with the above-mentioned configuration, when it is distinguished by the photographic image distinction unit 36 that no non-clothed portrait image is included in the frame image data included in the print order information, the processing in the automatic print mode is continued, so that photograph prints are generated at high speed; in contrast, when it is distinguished by the photographic image distinction unit 36 that a non-clothed portrait image is included in the frame image data included in the print order information, switching is made to the inspection print mode by the mode switching unit, so that the inspection process performed with the operator's eyes, that is, the determination as to whether or not photograph prints should be generated, can be carried out.

Therefore, it becomes possible to securely distinguish whether or not any harmful image is included in the frame image data included in print order information, without causing degradation in the production efficiency of photograph prints.

In the following description, embodiments in which the mode switching unit 60 makes a switch from the automatic print mode to the inspection print mode depending on predetermined conditions will be discussed.

### First Embodiment

When it is distinguished by the photographic image distinction unit 36 that any non-clothed portrait image is included in the frame image data, the mode switching unit 60 may execute a switch from the automatic print mode to the inspection print mode with respect to only the corresponding frame image.

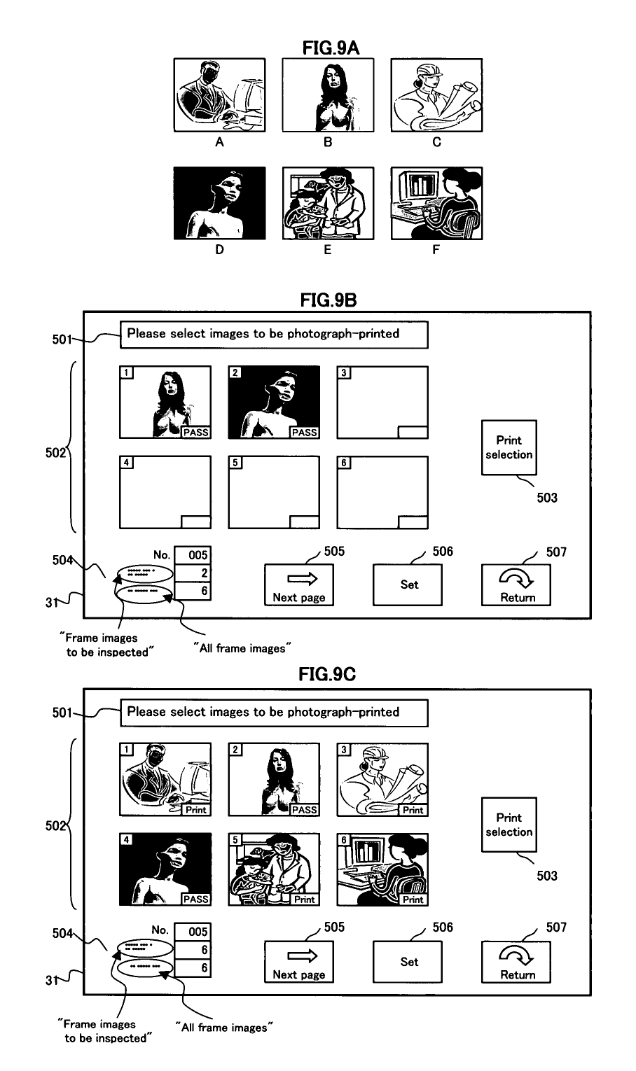

For example, in the case where the automatic print mode has been set by the mode switching unit 60, as shown in FIG. 9A, when processing print order information corresponding to six frame images A to F including frame image B and frame image D that are non-clothed portrait images, the photographic image distinction unit 36 performs distinction processing as to whether any non-clothed portrait image is included, from the leading frame image A in succession.

In the automatic print mode, processes of generating photograph prints are carried out one by one on the frame images that have been distinguished as no non-clothed portrait image being included therein in the distinction process. In contrast, with respect to the frame image B that has been distinguished as a non-clothed portrait image in the distinction process by the photographic image distinction unit 36, the process of generating photographic prints is not carried out, and at the time of the distinction, the corresponding frame image B is stored in the image data storage unit 30 by the mode switching unit 60. In this embodiment, the frame image D is also distinguished as a non-clothed portrait image by the photographic image distinction unit 36, and stored in the image data storage unit 30.

After the distinction processes have been carried out on the last frame image F or on the last frame image of a plurality of pieces of print order information and the processes of generating permitted photograph prints have been completed, the mode switching unit 60 executes a switch from the automatic print mode to the inspection print mode, and the image inspection unit 50 displays the stored frame images B and D on the display unit 31, as shown in FIG. 9B.

With respect to the frame images B and D distinguished by the photographic image distinction unit 36 as including a non-clothed portrait image, the operator views the screen and when it is determined that a photograph print should be generated, the process of generating the photograph print is carried out on the frame image selected to be printed.

With this configuration, since each time the photographic image distinction unit distinguishes that any non-clothed portrait image is included in frame image data, the mode switching unit switches the mode to the inspection pint mode, it is possible to securely ensure the opportunity of inspection by the operator with respect to the frame image distinguished as including a non-clothed portrait image.

### Second Embodiment

When it is distinguished by the photographic image distinction unit 36 that any non-clothed portrait image is included in the frame image data, the mode switching unit 60 may switch the mode from the automatic print mode to the inspection print mode with respect to only the one or a plurality of frame images that have been distinguished as including a non-clothed portrait image, on the basis of print order information including the corresponding frame image as one unit.

For example, in the case where print processing is carried out on print order information that consists of six frame images A to F as shown in FIG. 9A, with the frame image B and the frame image D including a non-clothed portrait image, the photographic image distinction unit 36 carries out distinction processes as to whether or not any non-clothed portrait image is included therein from the leading frame image A to the last frame image F in succession in the automatic print mode.

In the present configuration, since, although in the automatic print mode, print processing is carried out on the basis of the print order information as one unit, no process of generating the photograph print is carried out until the distinction processes have been completed on all the frame images with respect to the print order information.

As a result of the distinction process by the photographic image distinction unit 36, when any frame images (frame image B and frame image D) are distinguished as including a non-clothed portrait image, the mode switching unit 60 stores the frame images B and D in the image data storage unit 30.

Upon completion of the distinction processes up to the last frame image F, the mode switching unit 60 switches the mode from the automatic print mode to the inspection print mode. The image inspection unit 50 displays the frame images B and D stored in the image data storage unit 30 on the display unit 31, as shown in FIG. 9B.

With respect to the frame images B and D distinguished as including a non-clothed portrait image, the operator determines whether or not photograph print generation should be carried out, and the resulting one or two frame images selected to be printed and the frame images A, C, E and F distinguished as including no non-clothed portrait images are photograph-printed.

With this configuration, those frame image data distinguished as including no non-clothed portrait image among frame image data included in printed order information, are automatically photograph-printed on the basis of print order information, and with respect to only those frame image data distinguished as including a non-clothed portrait image, the switching is executed to the inspection print mode by the mode switching unit; therefore, it is possible to efficiently generate photograph prints, and also to securely ensure the opportunity of inspection by the operator with respect to the frame image distinguished as including a non-clothed portrait image.

### Third Embodiment

When it is distinguished by the photographic image distinction unit 36 that any non-clothed portrait image is included in frame image data, the mode switching unit 60 may switch the mode from the automatic print mode to the inspection print mode with respect to all the frame images, when the number or the rate of those frame images distinguished as including a non-clothed portrait image included in the print order information is equal to or exceeds a predetermined value, on the basis of the print order information including the corresponding frame image as one unit.

For example, in the case where print processing is carried out on print order information that consists of six frame images A to F as shown in FIG. 9A, with the frame image B and the frame image D including a non-clothed portrait image, the photographic image distinction unit 36 carries out distinction processes as to whether or not any non-clothed portrait image is included therein from the leading frame image A to the last frame image F in succession in the automatic print mode.

With the present configuration also, since, although in the automatic print mode, print processing is carried out on the basis of the print order information as one unit, no process of generating the photograph print is carried out until the distinction process has been completed on all the frame images with respect to the print order information.

As a result of the distinction process by the photographic image distinction unit 36, when any frame images frame image B and frame image D) are distinguished as including a non-clothed portrait image, the mode switching unit 60 stores the frame images B and D in the image data storage unit 30.

Upon completion of the distinction processes up to the last frame image F, the mode switching unit 60 switches the mode from the automatic print mode to the inspection print mode in the case where the number of the frame images B and D (two) stored in the image data storage unit 30 is a predetermined number or more, or in the case where the ratio of the number of the frame images B and D (two) to the number of the total frame images (six) is a predetermined ratio or more, with respect to the print order information, and the image inspection unit 50 displays all the frame images with respect to the print order information on the display unit 31, as shown in FIG. 9C.

Thereafter, the operator visually distinguishes all the frame images, and the process of generating the photograph print is carried out on each of the frame images selected to be printed among all the frame images.

In the case where the number or the rate of the frame image distinguished as including a non-clothed portrait image in one piece of print order information is equal to or exceeds a predetermined value, it can be assumed that the other frame images that have not been distinguished as including any non-clothed portrait image in the print order information also have a higher possibility of including any harmful image.

Since in such a case, the mode is switched to the inspection mode with respect to all the frame images included in the corresponding print order information by the mode switching unit, it is possible to securely ensure the opportunity of inspection by the operator even in the case of a harmful image that has not been distinguished as such by the photographic image distinction unit.

### Fourth Embodiment

When it is distinguished by the photographic image distinction unit 36 that any non-clothed portrait image is included in the frame image data, the mode switching unit 60 may switch the mode from the automatic print mode to the inspection print mode with respect to all the frame images, based upon print order information including the corresponding frame image as one unit.

For example, in the case where print processing is carried out on print order information that consists of six frame images A to F as shown in FIG. 9A, with the frame image B and the frame image D including non-clothed portrait images, the photographic image distinction unit 36 carries out distinction processes as to whether or not any non-clothed portrait image is included therein from the leading frame image A to the last frame image F in succession in the automatic print mode.

With the present configuration also, since, although in the automatic print mode, print processing is carried out on the basis of the print order information as one unit, no process of generating the photograph print is carried out until the distinction process has been completed on all the frame images with respect to the print order information.

As a result of the distinction process by the photographic image distinction unit 36, when the frame image B is distinguished as including a non-clothed portrait image, that is, when it is distinguished that even a single image includes a non-clothed portrait image in the print order information, the mode switching unit 60 switches the mode from the automatic print mode to the inspection print mode, and the image inspection unit 50 displays all the frame images with respect to the print order information on the display unit 31, as shown in FIG. 9C.

Thereafter, the operator visually distinguishes all the frame images, and the process of generating the photograph print is carried out on each of the frame images selected to be printed among all the frame images.

In the case where even a single image that has been distinguished as including a non-clothed portrait image by the photographic image distinction unit is included in one piece of print order information, the mode switching unit switches the mode from the automatic print mode to the inspection print mode with respect to all the frame images included in the piece of print order information; therefore, it becomes possible to securely ensure the opportunity of inspection by the operator.

### Fifth Embodiment

A harmfulness evaluation unit 70 for evaluating degree of harmfulness may be used to evaluate the degree of harmfulness of the image data distinguished as including a non-clothed portrait image by the photographic image distinction unit 36, and based upon the result of evaluation, the mode switching unit 60 can determine whether or not the automatic print mode should be switched to the inspection print mode.

For example, different degrees of harmfulness in which, between a portrait image with only a breast portion naked and a portrait image with the whole body naked, a higher degree of harmfulness is set for the portrait image with the whole body naked in comparison with the portrait image with only a breast portion naked may be used, and based upon the degree of harmfulness evaluated by the harmfulness evaluation unit 70, the mode switching unit 60 can determine whether or not the automatic print mode should be switched to the inspection print mode.

Moreover, for another example, different degrees of harmfulness in which, between an adult non-clothed portrait image and a minority non-clothed portrait image, a higher degree of harmfulness is set for the minority non-clothed portrait image in comparison with the adult non-clothed portrait image may be used, and based upon the degree of harmfulness evaluated by the harmfulness evaluation unit 70, the mode switching unit 60 can determine whether or not the automatic print mode should be switched to the inspection print mode.

In these examples, when it is distinguished by the photographic image distinction unit 36 that any non-clothed portrait image is included in frame image data and it is also evaluated by the harmfulness evaluation unit 70 that the degree of harmfulness is high, the mode switching unit 60 may switch the mode from the automatic print mode to the inspection print mode with respect to all the frame images, based upon print order information including the corresponding frame image as one unit.

For example, with respect to a photographic image processing apparatus 4 in which the harmfulness evaluation unit 70, which is set up such that the degree of harmfulness of the adult non-clothed portrait image is evaluated as “low”, with the degree of harmfulness of the minority non-clothed portrait image evaluated as “high”, and the mode switching unit 60, which is set up such that, only when the degree of harmfulness is “high”, the automatic print mode is switched to the inspection print mode with respect to all the frame images, are installed, the following description will be made on print processing to be carried out on print order information as shown in FIG. 9A (print order information which consists of six frame images A to F, with the frame image B including an adult non-clothed portrait image and the frame image D including a minority non-clothed portrait image).

The photographic image distinction unit 36 carries out distinction processes as to whether or not any non-clothed portrait image is included from the leading frame image A to the last frame image F in succession in the automatic print mode. In this case also, since print processing is carried out on the basis of the print order information as one unit, no process of generating the photograph print is carried out even in the automatic print mode, until the distinction processes have been completed on all the frame images with respect to the print order information.

In the distinction processes by the photographic image distinction unit 36, when the frame image B is distinguished as including a non-clothed portrait image, the harmfulness evaluation unit 70 determines whether the degree of harmfulness of the frame image B is “high” or “low”. In the present example, since the degree of harmfulness of the adult non-clothed portrait image is set as “low”, the distinction processes are continued without switching the mode from the automatic print mode with respect to all the frame images to the inspection print mode.

Next, in the distinction processes by the photographic image distinction unit 36, when the frame image D is distinguished as including a non-clothed portrait image, the harmfulness evaluation unit 70 determines whether the degree of harmfulness of the frame image D is “high” or “low”. In the present example, since the degree of harmfulness of the minority non-clothed portrait image is set as “high”, the automatic print mode is switched to the inspection print mode by the mode switching unit 60 so that, as shown in FIG. 9C, all the frame images with respect to the print order information are displayed on the display unit 31 by the image inspection unit 50.

The operator visually distinguishes all the frame images, and the process of generating the photograph print is carried out on each of the frame images selected to be printed among all the frame images.

Since it is really unsuitable to generate the photograph print of the image with a high degree of harmfulness, it is necessary to prevent the generation thereof as much as possible, and in the case where any frame image with a high degree of harmfulness is included in a piece of print order information, it is highly possible that an image with a high degree of harmfulness is also included in other frame images in the print order information.

Therefore, when it is distinguished that even a single image having a high degree of harmfulness is included in one piece of print order information, the switching is executed from the automatic print mode to the inspection print mode with respect to all the frame images, so that the operator is urged to carry out a strict inspection process.

Here, each of the above-described first to fifth embodiments may be achieved independently, or some of these may be achieved in combination. For example, when the number or the rate of frame images that are distinguished as including any non-clothed portrait image and are included in print order information is equal to or exceeds a predetermined value, the mode is switched from the automatic print mode to the inspection print mode with respect to all the frame images, and when the number or the rate of frame images that are distinguished as including any non-clothed portrait image and are included in the print order information is equal to or less than a predetermined value, only the frame images including a non-clothed portrait image may be displayed; in other words, the modes of the above-described second and third embodiments may be combined to achieve the present invention.

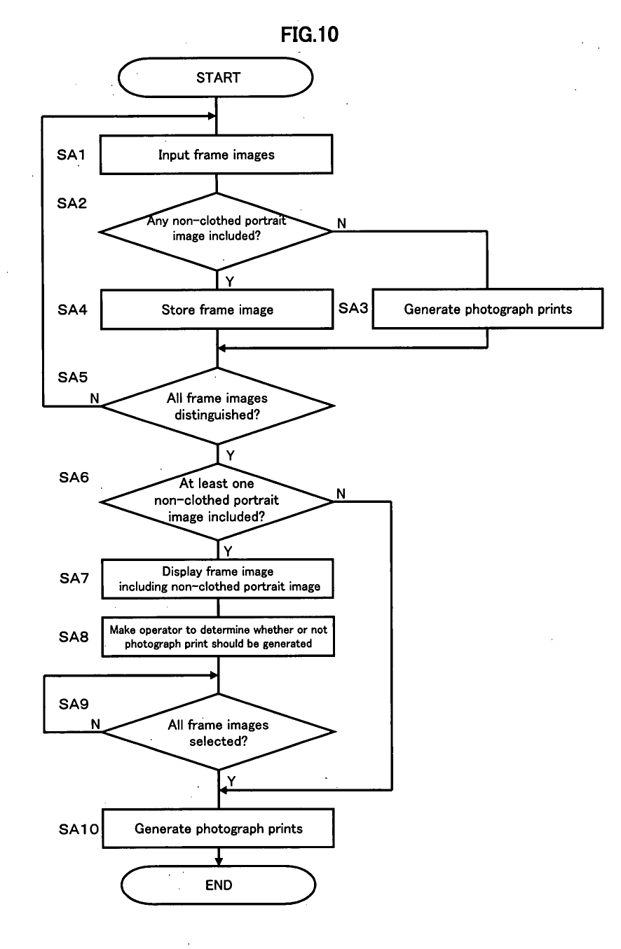

Referring to the flowcharts shown in FIGS. 10 to 13, the operations of the above-described first to fourth embodiments will be described in the following.

In the first embodiment, as shown in FIG. 10, when a frame image is inputted based on print order information (SA1), the photographic image distinction unit 36 determines whether or not the frame image includes any non-clothed portrait image (SA2), and in the case where no non-clothed portrait image is included, a photograph print generating process is carried out on the frame image (SA3), while in the case where a non-clothed portrait image is included, the mode switching unit 60 stores the frame image in the image data storage unit 30 (SA4). The above-described operations are carried out on all the frame images in the corresponding print order information (SA5).

When processes from step SA1 to step SA4 have been completed on all the frame images (SA5), the mode switching unit 60 distinguishes whether or not at least one frame image including a non-clothed portrait image is present in the print order information (SA6), and in the case where there is no frame image including any non-clothed portrait image, since the photograph print generating processes have already been completed on all the frame images, the processes are completed, while in the case where there is at least one frame image including a non-clothed portrait image, the automatic print mode is switched to the inspection print mode.

The image inspection unit 50 displays the frame image including a non-clothed portrait image on the display unit 31 (SA7), and with respect to the screen displayed on the display unit 31 as shown in FIG. 8, the operator makes determination as to whether or not a photograph print should be generated with respect to the displayed frame image (SA8).

When, upon completion of determination as to whether or not photograph prints should be generated with respect to all the frame images displayed on the screen (SA9), the operator presses a “set” switch 506 shown in FIG. 8, photograph prints are generated with respect to the frame images that have been selected to be photograph-printed (SA10).

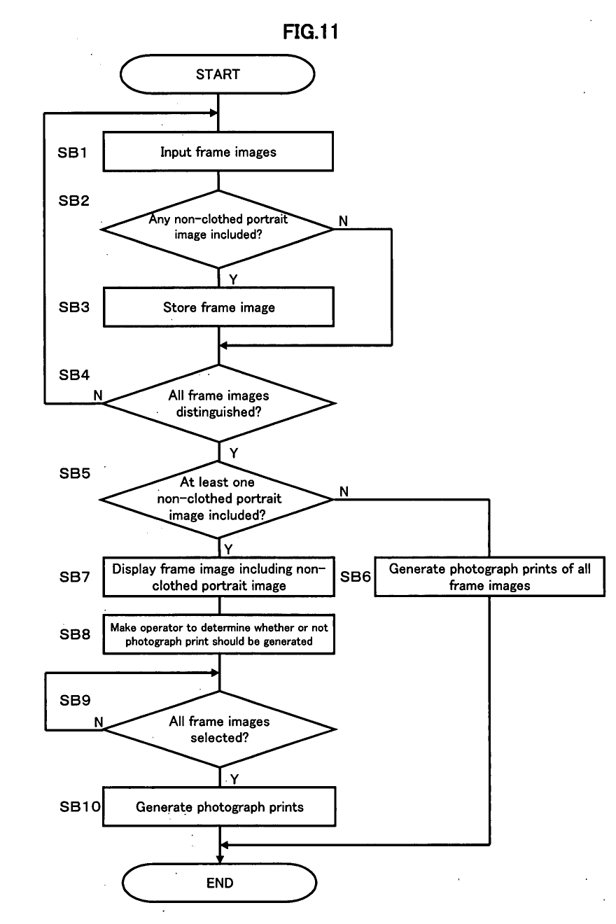

In the second embodiment, as shown in FIG. 11, when a frame image is inputted based on print order information (SB1), the photographic image distinction unit 36 determines whether or not the frame image includes any non-clothed portrait image (SB2), and in the case where a non-clothed portrait image is included, the mode switching unit 60 stores the frame image in the image data storage unit 30 (SB3). The above-described operations are carried out on all the frame images in the print order information (SB4).

When processes from step SB1 to step SB3 have been completed on all the frame images (SB4), the mode switching unit 60 distinguishes whether or not at least one frame image including any non-clothed portrait image is present in the print order information (SB5), and in the case where there is no frame image including any non-clothed portrait image, the photograph print generating processes are carried out on all the frame images to complete the processes (SB6), while in the case where there is at least one frame image including a non-clothed portrait image, the automatic print mode is switched to the inspection print mode.

The image inspection unit 50 displays the frame image including a non-clothed portrait image on the display unit 31 (SB7), and with respect to the screen displayed on the display unit 31 as shown in FIG. 8, the operator determines whether or not a photograph print generation should be carried out on the displayed frame image (SB8).

When, upon completion of the determination as to whether or not a photograph print should be generated with respect to all the frame images displayed on the screen (SB9), the operator presses a “set” switch 506 shown in FIG. 8, photograph prints are generated with respect to those frame images distinguished as including no non-clothed portrait image as well as those frame images which, although they have been distinguished as including a non-clothed portrait image, are determined by the operator to be print-generated (SB10).

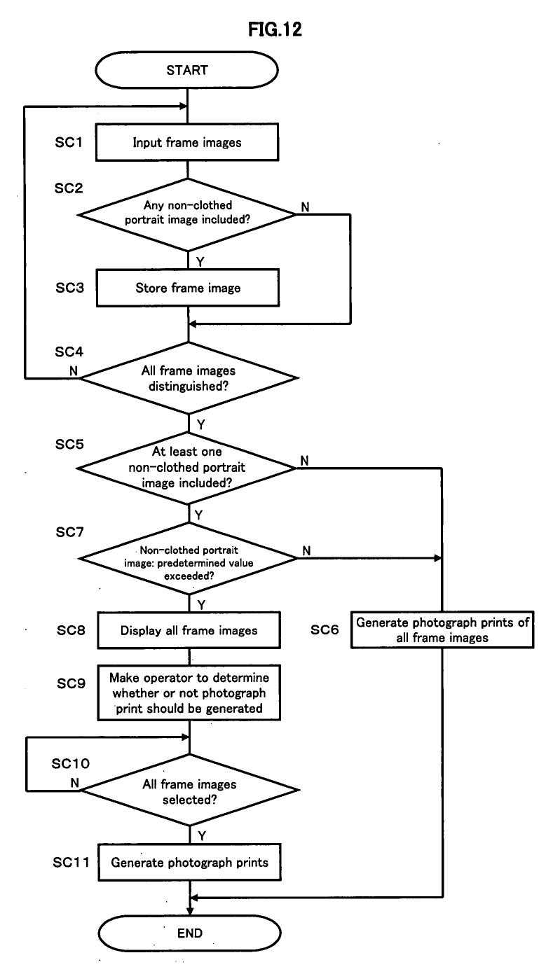

In the third embodiment, as shown in FIG. 12, when a frame image is inputted based on print order information (SC1), the photographic image distinction unit 36 determines whether or not the frame image includes any non-clothed portrait image (SC2), and in the case where a non-clothed portrait image is included, the mode switching unit 60 stores the frame image in the image data storage unit 30 (SC3). The above-described operations are carried out on all the frame images in the print order information (SC4).

When processes from step SC1 to step SC3 have been completed on all the frame images (SC4), the mode switching unit 60 distinguishes whether or not at least one frame image including a non-clothed portrait image is present in the print order information (SC5), and in the case where there is no frame image including any non-clothed portrait image, it carries out photograph print generating processes on all the frame images to complete the processes (SC6), while in the case where there is at least one frame image including a non-clothed portrait image, it determines whether or not the number or the rate of those frame images including non-clothed portrait images is equal to or exceeds a predetermined value (SC7).

In the case where, as a result of the determination in step SC7, the number or the rate is smaller than the predetermined value (SC7), photograph print generating processes are carried out on all the frame images to complete the processes (SC6), while in the case where the number or the rate exceeds the predetermined value (SC7), the automatic print mode is switched to the inspection print mode.

The image inspection unit 50 displays all the frame images on the display unit 31 with respect to the print order information (SC8), and with respect to the screen displayed on the display unit 31 as shown in FIG. 8, the operator makes determination as to whether or not a photograph print should be generated with respect to each of the displayed frame images (SC9).

When, upon completion of determination as to whether or not photograph prints should be generated with respect to all the frame images displayed on the screen (SC10), the operator clicks a “set” switch 506 shown in FIG. 8 with a mouse, among all the frame images displayed on the screen, photograph prints are generated with respect to the frame images that have been selected by the operator to be photograph-printed (SC11).

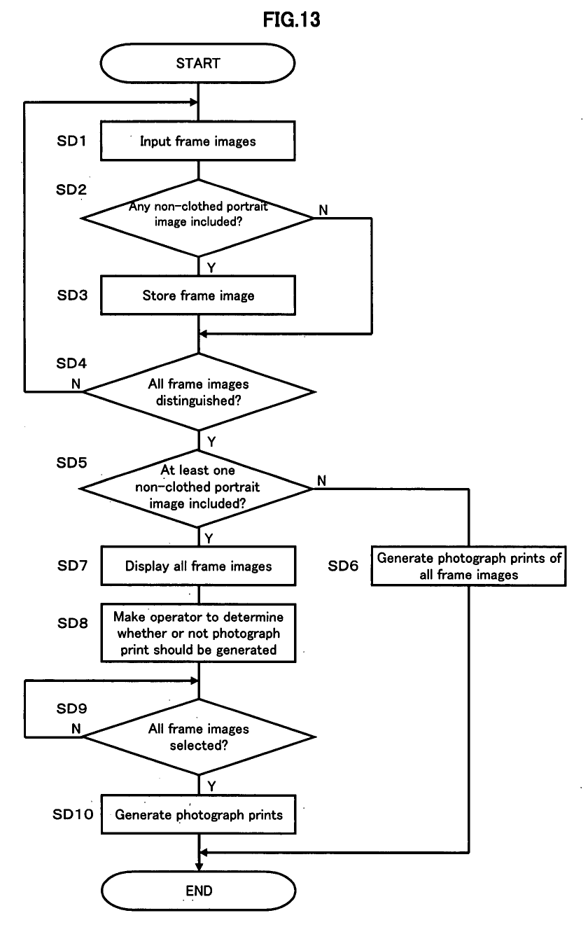

In the fourth embodiment, as shown in FIG. 13, when a frame image is inputted based on print order information (SD1), the photographic image distinction unit 36 determines whether or not the frame image includes any non-clothed portrait image (SD2), and in the case where a non-clothed portrait image is included, the mode switching unit 60 stores the frame image in the image data storage unit 30 (SD3). The above-described operations are carried out on all the frame images in the print order information (SD4).

When processes from step SD1 to step SD3 have been completed on all the frame images (SD4), the mode switching unit 60 distinguishes whether or not at least one frame image including a non-clothed portrait image is present in the print order information (SD5), and in the case where there is no frame image including any non-clothed portrait image, photograph print generating processes are carried out on all the frame images to complete the processes (SC6), while in the case where there is at least one frame image including a non-clothed portrait image, it switches the mode from the automatic print mode to the inspection print mode.

The image inspection unit 50 displays all the frame images on the display unit 31 with respect to the print order information (SD7), and with respect to the screen displayed on the display unit 31 as shown in FIG. 8, the operator makes determination as to whether or not a photograph print should be generated with respect to each of the displayed frame images (SD8).

When, upon completion of determination as to whether or not photograph prints should be generated with respect to all the frame images displayed on the screen (SD9), the operator presses a “set” switch 506 shown in FIG. 8, among all the frame images displayed on the screen, photograph prints are generated with respect to the frame images that have been determined by the operator to be photograph-printed (SD10).

Other embodiments will be described in the following. In the above-described embodiments, the pose feature data to be extracted by the feature data extraction unit 46 is extracted from a face domain; however, the pose feature data may be extracted from a domain other than the face domain. For example, as long as they belong to a skin domain, constituent factors such as a height, the size and shape of breasts, the outline and size of waist and hips, etc. may be extracted as the pose feature data.

Another configuration may be proposed in which an alarming unit which, when switching the mode from the automatic print mode to the inspection print mode by the mode switching unit 60, gives a warning sound calling for an operator's attention, is installed.

In the above-described embodiments, the photographic image processing apparatus 4 has the automatic print mode as the initial mode, and depending on conditions, that is, based upon the result of the determination by the photographic image distinction unit 36, the automatic print mode is switched to the inspection print mode by the mode switching unit 60; however, the initial mode may be set to the inspection print mode.

In the above-described embodiments, a structure has been described in which, after having determined as to whether or not a photograph print generation should be carried out with respect to all the frame images displayed on the screen of the display unit 31 as shown in FIG. 8, photograph print generating processes are carried out on all the displayed frame images at one time by pressing the “set” switch 506; however, another structure may be used in which each time each of the displayed frame images is selected, the photograph print is generated.

For example, in FIG. 8, when the print selection switch 503 for making selection as to whether or not a frame image made active on the screen should be print-generated, is pressed, a photograph print generating process may be carried out promptly only on the frame image.

In the above-described embodiments, the photographic image processing apparatus 4 has been described as having a structure which processes photographic image data inputted through the reception terminal 1; however, the photographic image processing apparatus 4 may have a film scanner, so that frame images stored in a photograph film received from a customer M can be read by the film scanner.

In the above-described embodiments, the photograph print order system is described as having a structure in which, as shown in FIG. 2, the reception terminal 1 installed in the photographic laboratory store deals with a customer M, that is, serves as an automatic receptionist; however, the photograph print order system may have a structure other than this structure.

For example, a salesclerk who is in charge of the job at the photographic laboratory store receives a storage medium or a photograph film in which photographic image data is stored from a customer M, and the finished photograph prints may be passed to the customer M, that is, a system in which the salesclerk takes cares of the customer M may be used.

Moreover, another system may be used in which a customer M orders the print of photographic image data via a cellular phone, the Internet, etc. More specifically, the customer M may transmit photographic image data to a photo laboratory store or a WEB server or the like that supervises a large number of photo laboratory stores to place the order of the print of the photographic image data from a remote location. Settlement of the charge is performed through payment by credit card via a cellular phone, the Internet, etc. In this system, when the photograph print is finished, the photo laboratory store that has prepared the print informs the customer M of the fact that the photograph print is ready directly through his or her cellular phone, or by way of the WEB server, or sends mails informing of the fact to the customer M.

It should be understood that while the above embodiments illustrate the present invention, they are exemplary only, and any modifications may be made on the specific structures of each of blocks, within the functions and effects produced by the present invention.

What is claimed is:

1. A photographic image processing apparatus, which generates photograph prints in a predetermined order based upon a plurality of pieces of inputted print order information, and outputs the photograph prints, comprising:
an image inspection unit which displays thumbnail images corresponding to one or a plurality of pieces of frame image data included in the inputted print order information on a display unit, and is capable of carrying out a predetermined inspection process on the frame images corresponding to the displayed thumbnail images;
a mode switching unit which switches modes between an inspection print mode that generates a photograph print based on a result of the inspection by the image inspection unit and an automatic print mode that generates a photograph print without using the image inspection unit; and
a photographic image distinction unit which distinguishes whether or not any non-clothed portrait image is included in the frame image data included in the print order information,
wherein the mode switching unit switches the mode from the automatic print mode to the inspection print mode based upon a result of the distinction by the photographic image distinction unit.

2. The photographic image processing apparatus according to claim 1, wherein, when it is distinguished by the photographic image distinction unit that the frame image data includes a non-clothed portrait image, the mode switching unit switches the mode from the automatic print mode to the inspection print mode only for the frame image.

3. The photographic image processing apparatus according to claim 1, wherein, when it is distinguished by the photographic image distinction unit that the frame image data includes a non-clothed portrait image, the mode switching unit switches the mode from the automatic print mode to the inspection print mode for all the frame images on the basis of the print order information including the corresponding frame image as one unit.

4. The photographic image processing apparatus according to claim 1, wherein, when it is distinguished by the photographic image distinction unit that the frame image data includes a non-clothed portrait image, the mode switching unit switches the mode from the automatic print mode to the inspection print mode for all the frame images on the basis of the print order information including the corresponding frame image as one unit, on the condition that the number or the rate of the frame images that are distinguished as including a non-clothed portrait image and included in the print order information is equal to or exceeds a predetermined value.

5. The photographic image processing apparatus according to claim 1, further comprising:
a harmfulness evaluation unit that evaluates degree of harmfulness of the image data that has been distinguished by the photographic image distinction unit as including a non-clothed portrait image,
wherein, when it is distinguished by the photographic image distinction unit that the frame image data includes a non-clothed portrait image and it is also evaluated by the harmfulness evaluation unit that the degree of harmfulness is high, the mode switching unit switches the mode from the automatic print mode to the inspection print mode for all the frame images on the basis of the print order information including the corresponding frame image as one unit.

6. The photographic image processing apparatus according to claim 1, wherein, when it is distinguished by the photographic image distinction unit that the frame image data includes a non-clothed portrait, image, the mode switching unit switches the mode from the automatic print mode to the inspection print mode only for one or a plurality of frame images that have been distinguished as including a non-clothed portrait image on the basis of the print order information including the corresponding frame image as one unit.

7. The photographic image processing apparatus according to claim 6, wherein, when it is distinguished by the photographic image distinction unit that the frame image data includes a non-clothed portrait image, the mode switching unit switches the mode from the automatic print mode to the inspection print mode for all the frame images on the basis of the print order information including the corresponding frame image as one unit, on the condition that the number or the rate of the frame images that are distinguished as including a non-clothed portrait image and included in the print order information is equal to or exceeds a predetermined value.

8. The photographic image processing apparatus according to claim 6, further comprising:
a harmfulness evaluation unit that evaluates degree of harmfulness of the image data that has been distinguished by the photographic image distinction unit as including a non-clothed portrait image,
wherein, when it is distinguished by the photographic image distinction unit that the frame image data includes a non-clothed portrait image and it is also evaluated by the harmfulness evaluation unit that the degree of harmfulness is high, the mode switching unit switches the mode from the automatic print mode to the inspection print mode for all the frame images on the basis of the print order information including the corresponding frame image as one unit.
